(19) United States
(12) Patent Application Publication
(10) Pub. No.: US 2018/0099428 A1
(43) Pub. Date: Apr. 12, 2018

(54) BAND CUTTER ASSEMBLY FOR COIL DEPLOYMENT APPARATUS AND METHOD OF UTILIZING SAME

(71) Applicant: Trinity Bay Equipment Holdings, LLC, Houston, TX (US)

(72) Inventors: Matthew Allen Hegler, Kingwood, TX (US); Alexander Ryan Barnett, Houston, TX (US)

(21) Appl. No.: 15/729,020

(22) Filed: Oct. 10, 2017

Related U.S. Application Data
(60) Provisional application No. 62/406,234, filed on Oct. 10, 2016.
(60) Provisional application No. 62/438,647, filed on Dec. 23, 2016.

(51) Int. Cl. B26D 1/04; B26D 7/01; B26D 7/06

(52) U.S. Cl. CPC B26D 1/045; B26D 7/06; B26D 7/01

(57) ABSTRACT

A band cutter assembly and related methods for cutting bands used to bind coils of flexible pipe used in the oil and gas industry are provided. Band-cutter assembly can be disposed on a coil deployment apparatus, or alternatively, can be disposed on a separate apparatus that is disposed on and/or adjacent to a coil deployment apparatus and capable of bringing the band-cutter assembly into proximity with retaining bands on a coil of flexible pipe.

### CROSS-REFERENCE TO RELATED APPLICATIONS

This application claims the benefit, and priority benefit, of U.S. Provisional Application No. 62/406,234 filed Oct. 10, 2016, and U.S. Provisional Application No. 62/438,647 filed Dec. 23, 2016, the disclosures of which are incorporated by reference herein in their entirety.

### BACKGROUND

Flexible pipe has a variety of uses in the oil and gas industry, and can be utilized in many different operating environments. Different types of devices and vehicles are currently used for loading and transporting the flexible pipe. The flexible pipe is often bundled and arranged into one or more coils to facilitate ease of transportation. At the job site, the coiled pipe can be deployed (also referred to as uncoiling or unspooling) and utilized for its intended purpose. Improvements in this field of technology are desired.

### SUMMARY

In certain illustrative embodiments, a band cutter assembly for cutting a retaining band on a coil of flexible pipe is provided. The band cutter assembly can include a band cutter sleeve having a hollow interior, a band cutter shaft having a proximal end and a distal end, and the distal end of the band cutter shaft is slidingly disposable within the band cutter sleeve, and a cutting instrument having at least one cutting blade, and the cutting instrument is disposed on the proximal end of the band cutter shaft. The band cutter assembly can also include a helical spring disposed longitudinally with respect to the band cutter shaft and the band cutter sleeve. The helical spring can have a first end connectable to the band cutter shaft and a second end connectable to the band cutter sleeve, and the helical spring can be capable of moving the band cutter shaft between an extended position and a retracted position with respect to the band cutter sleeve. The helical spring can be disposed inside the hollow interior of the band cutter sleeve and outside the band cutter shaft. The cutting instrument can have a first arm and a second arm each having a distal end and a proximal end, and the distal ends of the first arm and the second arm can be separated by a gap and the proximal ends of the first arm and the second arm can be connected to each other by a frame. The cutting instrument can be generally horseshoe-shaped. A blade can be disposed on at least one of the first arm and the second arm of the cutting instrument, on the opposite side of the arm on which the blade is disposed from the gap. The band cutter assembly can include a first torsion spring disposed between the band cutter shaft and the first arm of the cutting instrument and a second torsion spring disposed between the band cutter shaft and the second arm of the cutting instrument. The first torsion spring and the second torsion spring can be capable of moving the cutting blade from a non-aligned position to an aligned position with respect to the band cutter shaft. The first torsion spring can have a first leg that is connectable to the band cutter shaft and a second leg that is connectable to the first arm of the cutting instrument. The second torsion spring can have a first leg that is connectable to the band cutter shaft and a second leg that is connectable to the second arm of the cutting instrument. The band cutter assembly can also have an actuator operatively coupled to the cutting instrument, and the actuator can be capable of moving the cutting instrument linearly between an extended position and a retracted position.

In certain illustrative embodiments, a band cutter apparatus for cutting a retaining band on a coil of flexible pipe is provided. The band cutter apparatus can include a band cutter assembly and an advancing assembly. The band cutter assembly can include a band cutter sleeve having a hollow interior, a band cutter shaft having a proximal end and a distal end, and the distal end of the band cutter shaft can slidingly disposable within the band cutter sleeve, and a cutting instrument having at least one cutting blade, and the cutting instrument can be disposed on the proximal end of the band cutter shaft. The advancing assembly can include an advancing assembly sleeve having a hollow interior, and an advancing assembly shaft having a proximal end and a distal end, and the distal end of the advancing assembly shaft can be slidingly disposable within the advancing assembly sleeve. The band cutter assembly can be disposed on the proximal end of the advancing assembly shaft. A helical spring can be disposed longitudinally with respect to the band cutter shaft and the band cutter sleeve. The helical spring can have a first end connectable to the band cutter shaft and a second end connectable to the band cutter sleeve. The helical spring can be capable of moving the band cutter shaft between an extended position and a retracted position with respect to the band cutter sleeve. An actuator can be operatively coupled to the advancing assembly shaft and capable of moving the advancing assembly shaft linearly from a retracted position to an extended position with respect to the advancing assembly sleeve. A bracing apparatus can be disposed on the advancing assembly and can be capable of contacting the coil of flexible pipe when the band cutter apparatus is positioned adjacent the coil of flexible pipe.

In certain illustrative embodiments, a method of cutting a retaining band on a coil of flexible pipe is provided. An advancing assembly can be disposed at a location adjacent to the coil of flexible pipe. The advancing assembly can have a cutting instrument disposed thereon and an actuator operatively coupled thereto. The cutting instrument can be advanced towards the coil of flexible pipe using the actuator. The retaining band can be cut with the cutting instrument. In certain aspects, the advancing assembly can also include a bracing apparatus, and the bracing apparatus can be advanced towards the coil of flexible pipe. The bracing apparatus can contact the coil of flexible pipe. In certain aspects, the coil of flexible pipe can be rotated about its central axis, and the bracing apparatus can be continuously advanced towards the coil of flexible pipe as one or more strands of flexible pipe unspool from the coil and one or more additional layers of flexible pipe are exposed. The bracing apparatus can be contacted with the one or more additional layers of flexible pipe.

In certain illustrative embodiments, a method of cutting a retaining band on a coil of flexible pipe is provided. An advancing assembly can be disposed adjacent to the coil of flexible pipe. The advancing assembly can include an advancing assembly sleeve having a hollow interior, an advancing assembly shaft slidingly disposable within the advancing assembly sleeve, and a cutting instrument having at least one cutting blade, and the cutting instrument can be disposed on the proximal end of the advancing assembly shaft. The cutting instrument can be advanced towards the coil of flexible pipe, and the retaining band can be cut with the cutting instrument. The step of advancing the cutting instrument towards the coil of flexible pipe can include moving the advancing assembly shaft linearly from a retracted position to an extended position with respect to the advancing assembly sleeve. The advancing assembly shaft can be moved by an actuator operatively coupled to the advancing assembly shaft. A plurality of recesses can be disposed between the individual pipe strands on the coil of flexible pipe, and the cutting instrument can be advanced to fit within one of the recesses. The coil of flexible pipe can be rotated about its central axis such that the cutting instrument comes into contact with the retaining band.

In certain aspects, a band cutter assembly can be disposed on the advancing assembly shaft. The band cutter assembly can include a band cutter sleeve having a hollow interior, a band cutter shaft having a proximal end and a distal end, and the distal end of the band cutter shaft can be slidingly disposable within the band cutter sleeve, and a cutting instrument having at least one cutting blade, and the cutting instrument can be disposed on the proximal end of the band cutter shaft. The band cutter assembly can also include a helical spring disposed longitudinally with respect to the band cutter shaft and the band cutter sleeve. The helical spring can have a first end connectable to the band cutter shaft and a second end connectable to the band cutter sleeve. The helical spring can be capable of moving the band cutter shaft between an extended position and a retracted position with respect to the band cutter sleeve. The helical spring can move the cutting blade from the extended position to the retracted position with respect to the band cutter sleeve when the cutting instrument comes into contact with the coil of flexible pipe. The helical spring can move also the cutting blade from the retracted position to the extended position with respect to the band cutter sleeve when the cutting instrument comes out of contact with the coil of flexible pipe.

In certain aspects, the band cutter assembly can also include a first torsion spring disposed between the band cutter shaft and the first arm of the cutting instrument and a second torsion spring disposed between the band cutter shaft and the second arm of the cutting instrument. The first torsion spring and the second torsion spring can be capable of moving the cutting blade between a non-aligned position and an aligned position with respect to the band cutter shaft. The first torsion spring and the second torsion spring can also move the cutting blade from an aligned position to a non-aligned position with respect to the band cutter shaft when the cutting instrument comes into contact with the coil of flexible pipe. In certain aspects, the first torsion spring and the second torsion spring can move the cutting blade from a non-aligned position to an aligned position with respect to the band cutter shaft when the cutting instrument comes out of contact with the coil of flexible pipe. The band cutter assembly can also include a helical spring disposed longitudinally with respect to the band cutter shaft and the band cutter sleeve, and the helical spring can have a first end connectable to the band cutter shaft and a second end connectable to the band cutter sleeve, and the helical spring can be capable of moving the band cutter shaft between an extended position and a retracted position with respect to the band cutter sleeve. The band cutter assembly can also include a first torsion spring disposed between the band cutter shaft and the first arm of the cutting instrument and a second torsion spring disposed between the band cutter shaft and the second arm of the cutting instrument, and the first torsion spring and the second torsion spring can be capable of moving the cutting blade from a non-aligned position to an aligned position with respect to the band cutter shaft. In certain aspects, the helical spring can move the cutting blade from the extended position to the retracted position with respect to the band cutter sleeve when the cutting instrument comes into contact with the coil of flexible pipe, and from the retracted position to the extended position with respect to the band cutter sleeve when the cutting instrument comes out of contact with the coil of flexible pipe, and the first torsion spring and the second torsion spring can move the cutting blade from an aligned position to a non-aligned position with respect to the band cutter shaft when the cutting instrument comes into contact with the coil of flexible pipe, and from a non-aligned position to an aligned position with respect to the band cutter shaft when the cutting instrument comes out of contact with the coil of flexible pipe.

### BRIEF DESCRIPTION OF THE DRAWINGS

A better understanding of the present invention can be obtained when the following detailed description of the preferred embodiment is considered in conjunction with the following drawings, in which:

FIG. 1 is a perspective view of one or more coils of flexible pipe sitting on one or more skids according to embodiments of the present disclosure.

FIG. 2 is a view of one or more coils of flexible pipe being moved on a coil deployment apparatus according to embodiments of the present disclosure.

FIG. 3 is a view of a coil deployment apparatus having a band cutter assembly according to embodiments of the present disclosure.

FIG. 4 is a perspective view of a band cutter assembly according to embodiments of the present disclosure.

FIG. 5 is an exploded perspective view of a band cutter assembly according to embodiments of the present disclosure.

FIGS. 6A-6D are side, top and perspective views of a band cutter assembly according to embodiments of the present disclosure.

FIGS. 7A-7B are side and perspective views of components of a band cutter assembly according to embodiments of the present disclosure.

FIGS. 8A-8C are side, front and perspective views of a cutting instrument for a band cutter assembly according to embodiments of the present disclosure.

FIG. 9 is a perspective view of a band cutter apparatus according to embodiments of the present disclosure.

FIG. 10 is a perspective view of a band cutter apparatus according to embodiments of the present disclosure.

FIG. 11 is a perspective view of a band cutter apparatus according to embodiments of the present disclosure.

FIG. 12 is a perspective view of a band cutter apparatus according to embodiments of the present disclosure.

FIG. 13 is a perspective view of a band cutter apparatus according to embodiments of the present disclosure.

### DETAILED DESCRIPTION

Disclosed herein are various illustrative embodiments of a band cutter assembly and related methods for cutting bands used to bind coils of flexible pipe used in the oil and gas industry.

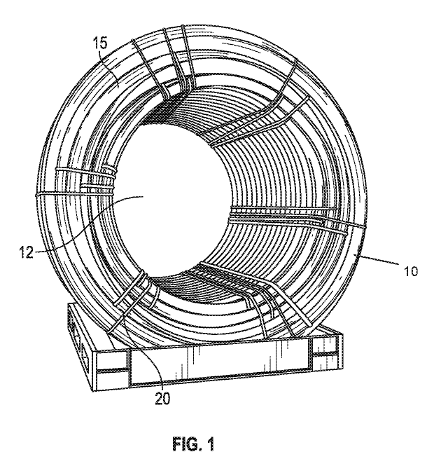

Flexible pipe 10 may be formed into a coil 15 and bound together using one or more bands 20. (See FIG. 1). Coil 15 may include multiple wound layers of pipe 10 that have been coiled into a particular shape or arrangement, and the various bands 20 retain the layers of pipe 10 at various thicknesses along coil 15. For example, coil 15 of pipe 10 can be coiled into a substantially cylindrical or oval shape having substantially circular or oval-shaped bases formed on each end of coil 15, where the axial dimension of coil 15 is measured between the two bases.

A pipe, as understood by those of ordinary skill in the art, may be a tube to convey or transfer any water, gas, oil, or any type of fluid. Pipe 10 used to make up coil 15 may be made of any type of materials including without limitation plastics, metals, a combination thereof, composites (e.g., fiber reinforced composites), or other materials known in the art.

In certain illustrative embodiments, pipe 10 used to make up coil 15 may be a flexible type of pipe. Flexible pipe is used frequently in many applications, including without limitation, both onshore and offshore oil and gas applications. Flexible pipe may include Flexible Composite Pipe (FCP) or Reinforced Thermoplastic Pipe (RTP). A FCP or RTP pipe may itself be generally composed of several layers. In one or more embodiments, a flexible pipe may include a high density polyethylene (“HDPE”) pipe having a reinforcement layer and an HDPE outer cover layer. Thus, flexible pipe may include different layers that may be made of a variety of materials and also may be treated for corrosion resistance. For example, in one or more embodiments, pipe 10 used to make up coil 15 of pipe 10 may have a corrosion protection shield layer that is disposed over another layer of steel reinforcement. In this steel reinforced layer, helically wound steel strips may be placed over a liner made of thermoplastic pipe. Flexible pipe may be designed to handle a variety of pressures. Further, flexible pipe may offer unique features and benefits versus steel/carbon steel pipe lines in the area of corrosion resistance, flexibility, installation speed and re-usability.

Coils 15 of pipe 10 may be made with coil 15 having an outer diameter ranging, for example, from about 2 inches (5.1 cm) to about 10 inches (25.4 cm). However, pipe 10 having other dimensions may be coiled to form coil 15 of pipe 10 and loaded to trailers according to embodiments of the present disclosure. Accordingly, pipe 10 that that may be spooled or coiled into coil 15 of pipe 10 may be made to suit a number of dimensions and may have any diameter useful to a particular project.

After being assembled into coil 15, coil 15 of pipe 10 may include an interior channel 12 formed axially through the coil of pipe 10. Interior channel 12 is a bore disposed generally in the center of coil of pipe 10. Interior channel 12 can be substantially circular shaped. The coil of pipe 10 may have an outer diameter (OD) and an inner diameter (ID), where the inner diameter is defined by the interior channel.

In certain illustrative embodiments, one or more bands 20 can be wrapped around coil 15 of pipe 10 (often times in a helical fashion) to keep coil 15 from unraveling. When the time comes for uncoiling or unspooling pipe 10, bands 20 can be cut at one or more desired locations.

Current methods for cutting bands 20 involve a user manually cutting bands 20 by hand with a hand-held cutting device such as a knife. The presently disclosed subject matter provides alternate means for cutting such bands 20.

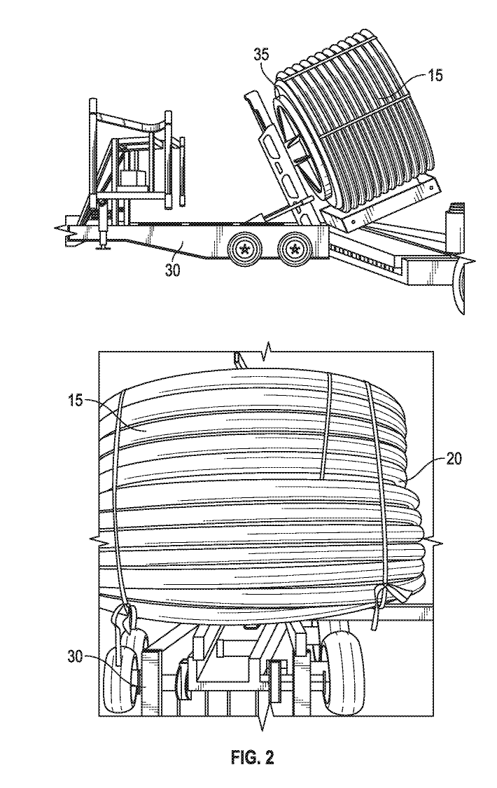

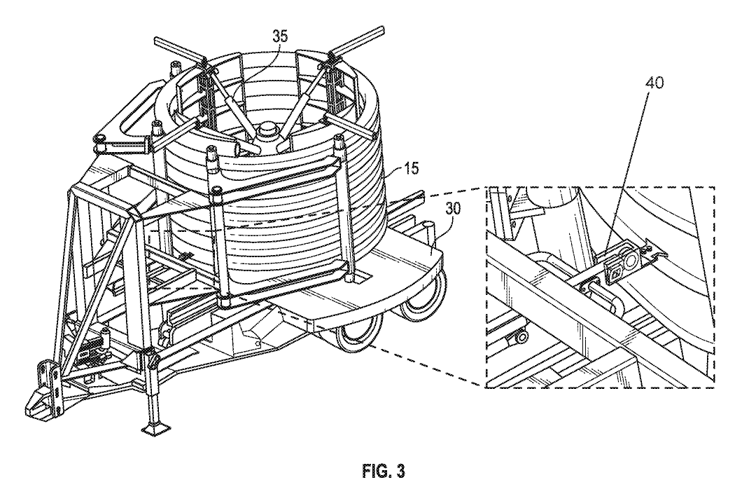

Referring now to FIGS. 2 and 3, coil 15 of pipe 10 can be stored on a coil deployment apparatus 30. Coil deployment apparatus 30 can be, for example, a trailer or other vehicle that is utilized to transport and/or deploy coils 15 of flexible pipe 10. Coil deployment apparatus 30 may comprise, for example, a trailer on a trailer bed with a lifting head 35 protruding outwardly from and movable relative to the trailer bed, where the lifting head may be used to hold or support coil 15 of pipe 10. In some embodiments, lifting head 35 may radially expand or contract to fit within and support the inner diameter of coil 15. In some embodiments, lifting head 35 may include a single lifting arm 36 (sometimes referred to as a “carpet pole”), which may be inserted through the inner diameter of coil 15. Coil deployment apparatus 30 can be utilized to rotate coil 15 of pipe 10 in either a clockwise or counterclockwise direction for the purpose of deploying pipe 10 for use. Representative, non-limiting examples of coil deployment apparatus are shown and/or described in U.S. Pat. No. 8,985,496 titled “Expandable drum assembly for deploying coiled pipe” issued Mar. 24, 2015, the disclosure of which is incorporated by reference herein in its entirety.

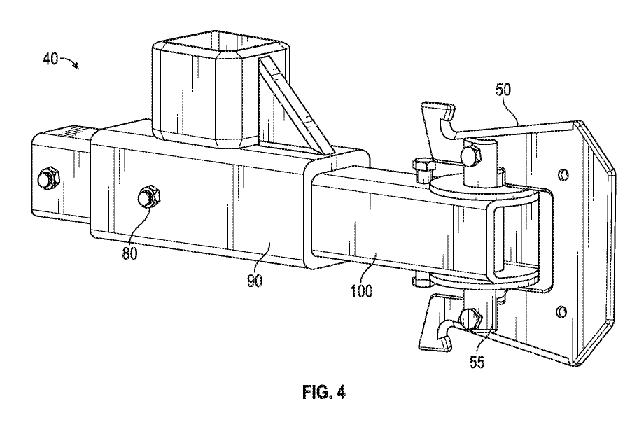

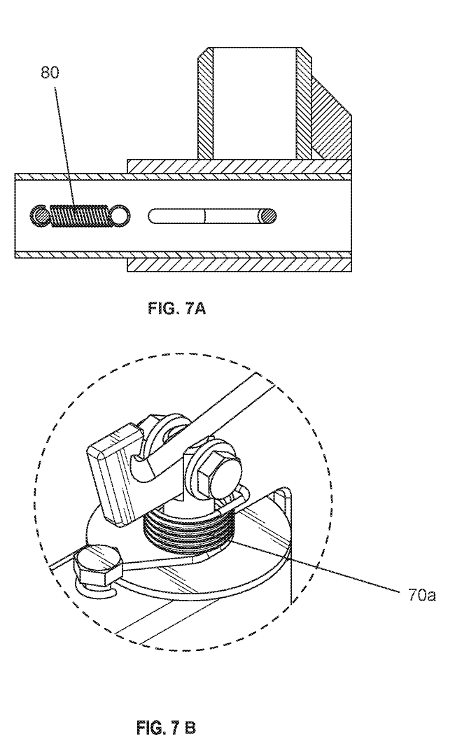

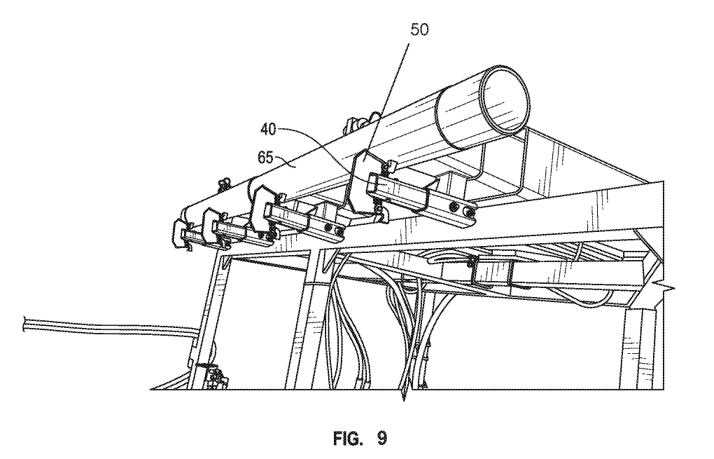

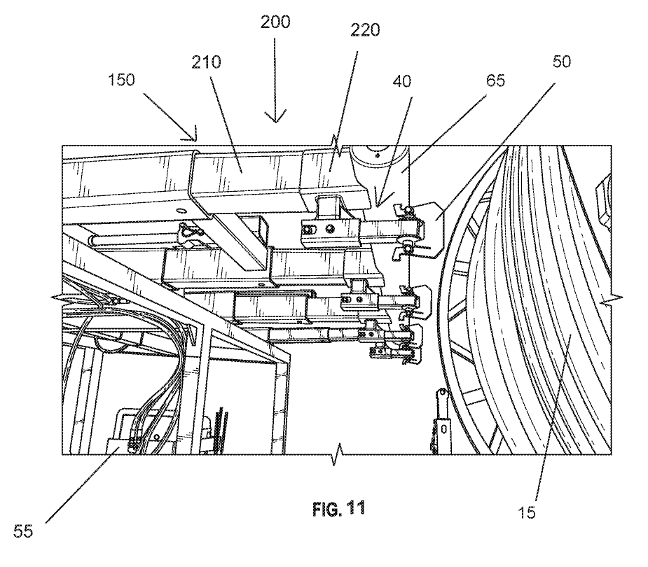

Illustrative embodiments of a band cutter assembly 40 and related equipment and components are shown in FIGS. 4-13 herein. Band-cutter assembly 40 can be disposed on coil deployment apparatus 30, or alternatively, band-cutter assembly 40 can be disposed on a separate apparatus that is disposed on and/or adjacent to coil deployment apparatus 30 and capable of bringing band-cutter assembly 40 into proximity with coil 15 of pipe 10.

Band cutter assembly 40 can include an integrated cutting instrument 50 which includes one or more blades or cutting knifes to cut bands 20 on coil 15. In certain illustrative embodiments, integrated cutting instrument 50 of band cutter assembly 40 can have a U-shaped or horseshoe-shaped configuration and can be mounted on band cutter assembly 40 via a pivoting mechanism. In other embodiments, integrated cutting instrument 50 of band cutter assembly 40 can have other shapes such as chevron-shaped, straight edge, curved (convex or concave), etc. Band cutter assembly 40 can also include more than one cutting instrument 50 disposed thereon (that is, a plurality of cutting instruments 50) depending on the need to cut coils 15 having different sizes or locations of bands 20.

In certain illustrative embodiments, band-cutter assembly 40 can be auto-positioning. For example, band cutter assembly 40 can be mounted in place on coil deployment apparatus 30 or the separate adjacent apparatus and be capable of always being in a position to effectively cut bands 20 with no direct human interaction. Band cutter assembly 40 can cut bands 20 when coil 15 is stationary, or alternatively, as coil 15 rotates about a central axis via coil deployment apparatus 30. This is an improvement over current methods which involve stopping the pipe deployment process and manually cutting bands 20 by hand with the use of a hand-held cutting device. The presently disclosed auto positioning band cutter assembly 40 will increase the level of safety and efficiency of deploying coil 15.

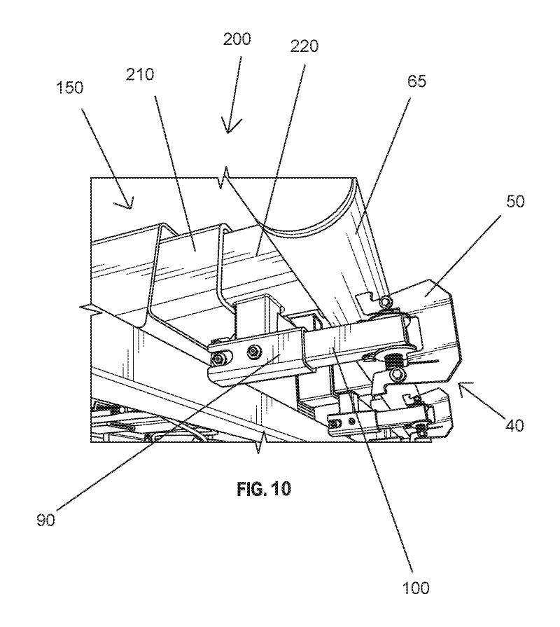

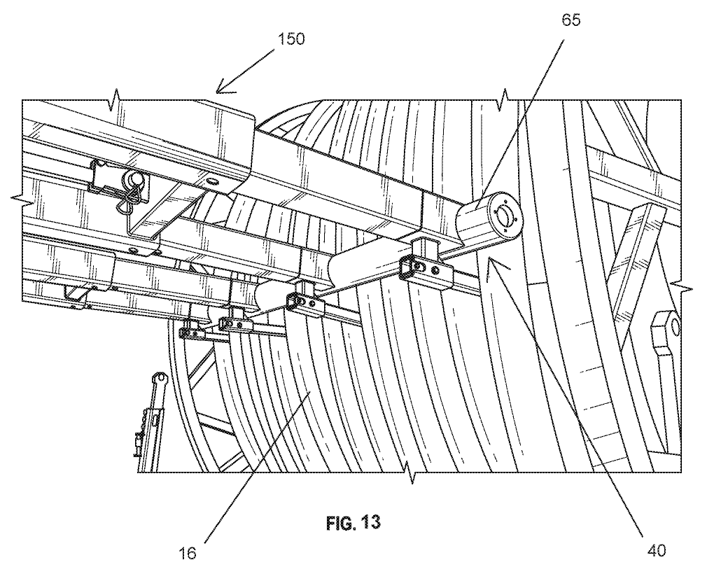

In certain illustrative embodiments, band cutter assembly 40 can be mounted to a bracing apparatus 65 on coil deployment apparatus 30 or a separate adjacent apparatus (see, e.g., FIGS. 10-13). Bracing apparatus 65 can be moved towards coil 15 and pushed into, or near, contact with coil 15 such that cutting instrument 50 is in proximity with coil 15. This allows cutting instrument 50 to fit between the recesses created between individual strands of pipe 10 packaged as coil 15. See, e.g., FIG. 13. As pipe 10 is being deployed, coil rotates 15 about a centrally located axis on coil deployment apparatus 30. Bands 20 on coil 15 are preferably cut by cutting instrument 50 just prior to a segment of pipe 10 adjacent to said bands 20 being deployed from coil deployment apparatus 30.

In certain illustrative embodiments, bracing apparatus 65 can be a braking assembly 60. As such, brake assembly 60 is a touching point on coil 15 during deployment and brake assembly 60 makes contact with pipe 10 on coil 15 to prevent or restrict rotational motion. The band cutter is allowed to rotate as the helix of the coil moves from left to right (or right to left) and also has the ability to move axially backwards behind the brake. In certain illustrative embodiments, band cutter will also have the capability of being pulled back when the two part brake is misaligned to prevent cutting of the banding on the next layer of pipe. As a result, coil 15 will decrease in radius as pipe 10 is spooled off of coil 15, and bracing apparatus 65 will continue to advance towards coil 15 and contact coil 15 while cutting instrument 50 cuts retaining bands 20 on newly exposed layers of coil 15. This is to provide tension against coil 15 and prevent, or reduce the likelihood of, free spooling of coil 15 after one or more of retaining bands 20 are cut.

In certain illustrative embodiments, band cutter assembly 40 is hydraulically-powered. For example, cutting instrument 50 can be moved in and out of engagement with the bands 20 with a belly-pack control unit or other similar type of actuator 55. In certain illustrative embodiments, actuator 55 can be operatively coupled to cutting instrument 50, such that actuator 55 is capable of moving cutting instrument 50 linearly between an extended position (closer to coil 15 of pipe 10) and a retracted position (further from coil 15 of pipe 10) with respect to band cutter assembly 40. In other embodiments, cutting instrument 50 or its related components can be pulled back from engagement with coil 15 via a hook and cable or other like mechanism.

In certain illustrative embodiments, band cutter assembly 40 has one or more springs to adjust and/or control the positioning of cutting instrument 50 with respect to coil 15. Thus, band cutter assembly 40 can adjust to the helically-wrapped geometry of pipe 10.

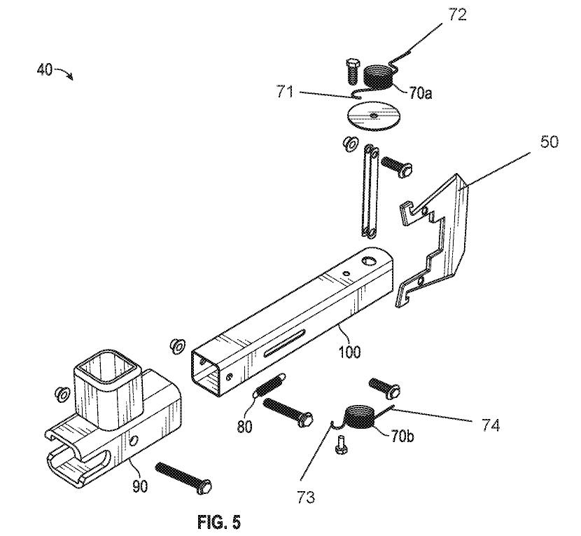

For example, band cutter assembly 40 can have one or more angular positioning torsion springs 70 disposed thereon. As shown in, e.g., the exploded view of FIG. 5, angular positioning torsion springs 70 of band cutter assembly 40 can include a first built-in self-righting spring 70a and a second built-in self-righting spring 70b disposed thereon. First built-in self-righting spring 70a and second built-in self-righting spring 70b can control motion of cutting instrument 50 in a “side-to-side” or “up-down” orientation. First built-in self-righting spring 70a and second built-in self-righting spring 70b can allow cutting instrument 50 to move on a hinge and either be aligned at 0° with the recesses created between individual strands of pipe 10 in coil 15, or alternatively, move from greater than 0° to 90° to the right, or from greater than 0° to 90° to the left, respectively.

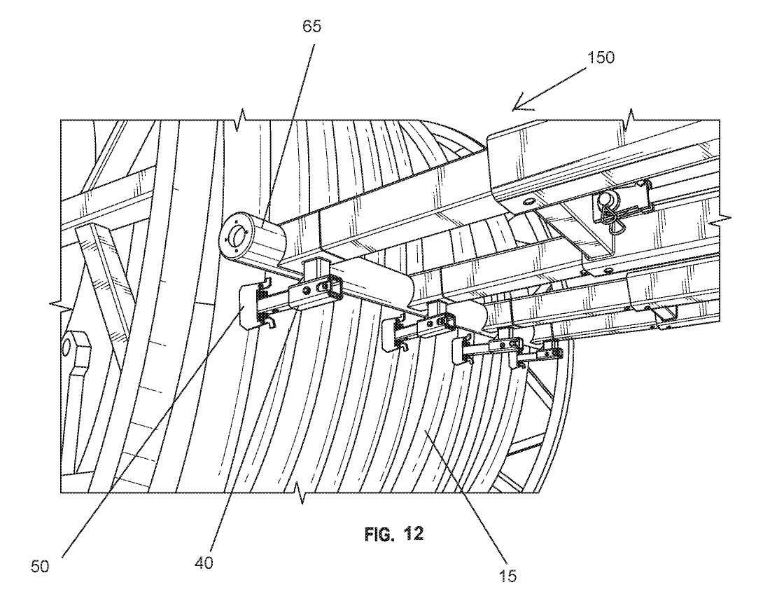

For example, as coil 15 rotates to deploy pipe 10, band cutter assembly 40 can be disposed adjacent to coil 15. Cutting instrument 50 can contact the surface of pipe 15, and seek to fit between the recesses created between individual strands of pipe 10 (see, e.g., FIG. 12). These recesses can be aligned in parallel to each other, or more likely, they will have a random alignment associated the alignment of pipe 10 on coil 15. When cutting instrument 50 is able to fit within one of said recesses, cutting blade will be in the “engaged” position, and disposed to cut bands 20. When cutting instrument 50 is unable to fit within said recesses, angular positioning self-righting torsion springs 70 will fold cutting instrument 50 along the hinge and move cutting instrument 50 to the “disengaged” position, either to the right or left, until such time as cutting instrument 50 becomes aligned with another recess between individual strands of pipe 10 and slides within the recess, wherein cutting instrument 50 will move back to 0° alignment and cutting of the next most closely positioned retaining band 20 can occur (see, e.g., FIG. 13).

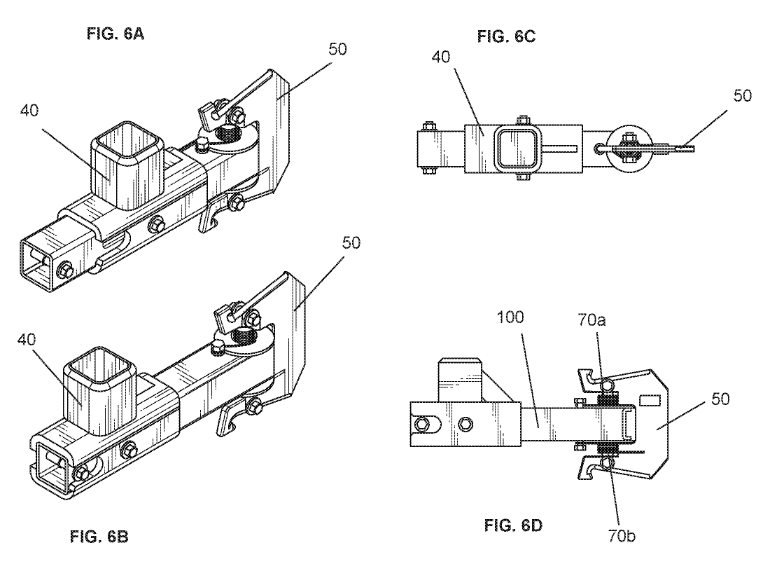

In certain illustrative embodiments, band cutter assembly 40 can also have one or more longitudinal positioning helical springs 80 disposed thereon, as shown in, e.g., the exploded view of FIG. 5. Longitudinal positioning helical springs 80 can be disposed within a hollow band cutter mount or sleeve 90, and can move a central band cutter shaft 100 forwards or backwards within band cutter mount or sleeve 90. Cutting instrument 50 can be dispose on an end of central band cutter shaft 100, such that the forward or backward movement thereof results in the cutting instrument 50 moving between an “extended” position (FIGS. 6B and 6D, bottom two figures) and a “retracted” position (FIGS. 6A and 6C, top two figures) with respect to band cutter mount 45. When cutting instrument 50 is in the “extended” position, cutting instrument 50 can contact and cut bands 50. When cutting instrument 50 is in the “retracted” position, cutting instrument 50 cannot contact and cut bands 50.

In certain illustrative embodiments, band cutter assembly 40 can include band cutter sleeve 90, band cutter shaft 100 and cutting instrument 50. Cutting instrument 50 can be disposed on the proximal end of the band cutter shaft 100, and can have at least one cutting blade. Band cutter sleeve 90 can have a hollow interior, and the distal end of the band cutter shaft 100 can be slidingly disposable within the band cutter sleeve 90. The one or more cutting blades of cutting instrument 50 can disposed on the proximal end of band cutter shaft 100.

In certain illustrative embodiments, one or more helical springs 80 can be disposed longitudinally with respect to band cutter shaft 100 and band cutter sleeve 90, wherein helical spring 80 each have a first end connectable to band cutter shaft 100 and a second end connectable to band cutter sleeve 90. The one or more helical springs 80 can be capable of moving band cutter shaft 100 between an extended position and a retracted position with respect to band cutter sleeve 90. Helical springs 80 can be disposed, for example, inside the hollow interior of band cutter sleeve 90 and outside the exterior of band cutter shaft 100.

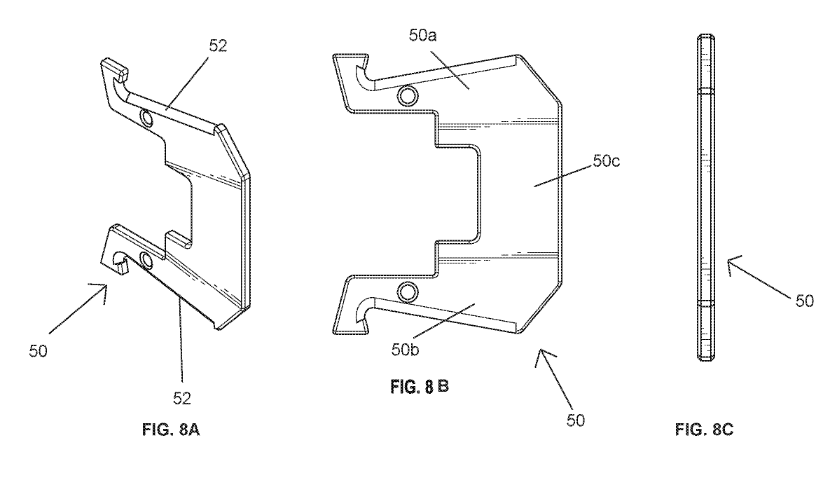

In certain illustrative embodiments, cutting instrument 50 can have a first arm 50a and a second arm 50b each having a distal end and a proximal end. The distal ends of first arm 50a and second arm 50b can be separated by a gap 51 and the proximal ends of first arm 50a and second arm 50b can connected to each other by a frame 50c. Cutting instrument 50 can be generally horseshoe-shaped in certain embodiment, as shown, for example, in FIGS. 5 and 8A-8B. A blade 52 can be disposed on at least one of first arm 50a and second arm 50b of cutting instrument 50. In certain embodiments, a blade 52 is disposed on each of first arm 50a and second arm 50b, on the opposite side of the arm 50a, 5b from gap 51, such that cutting instrument 50 can cut retaining band 20 when coil 15 is rotating in either a clockwise or counterclockwise direction. This also allows for redundancy if, for example, cutting instrument 50 needs to be removed and flipped over due to dull blades on one side.

In certain illustrative embodiments, band cutter assembly 40 can also include first torsion spring 70a disposed between band cutter shaft 100 and first arm 50a of cutting instrument 50 and second torsion spring 70b disposed between band cutter shaft 100 and second arm 50b of cutting instrument 50. First torsion spring 70a and second torsion spring 70b can move cutting instrument 50 from a non-aligned position to an aligned position with respect to band cutter shaft 100. First torsion spring 70a can has a first leg 71 that is connectable to band cutter shaft 100 and a second leg 72 that is connectable to first arm 50a of cutting instrument 50. Second torsion spring 70b can have a first leg 73 that is connectable to band cutter shaft 100 and a second leg 74 that is connectable to second arm 50b of cutting instrument 50.

In certain illustrative embodiments, such as for example, in FIG. 10, a band cutter apparatus 200 is provided for cutting a retaining band on a coil of flexible pipe. Band cutter apparatus 200 can include band cutter assembly 40 and an advancing assembly 150. Band cutter assembly 40 can include band cutter sleeve 90, band cutter shaft 100 and cutting instrument 50. Advancing assembly 150 can include an advancing assembly sleeve 210, an advancing assembly shaft 220, and actuator 55. Advancing assembly sleeve 210 can have a hollow interior, and advancing assembly shaft 220 can have a proximal end and a distal end, wherein the distal end of advancing assembly shaft 220 is slidingly disposable within advancing assembly sleeve 210. Band cutter assembly 40 can disposed on the proximal end of advancing assembly shaft 220.

In certain illustrative embodiments, band cutter apparatus 200 can include a plurality of band cutter assemblies 40 disposed on a single advancing assembly 150, or a plurality of advancing assemblies 150 each having its own dedicated band cutter assembly 40 or a plurality of band cutter assembly 40 disposed thereon, each embodiment depending on a variety of factor including but not limited to the need to cut coils 15 having different sizes or locations of bands 20.

In certain illustrative embodiments, actuator 55 can be operatively coupled to advancing assembly shaft 220 and capable of moving advancing assembly shaft 220 linearly from a retracted position to an extended position with respect to advancing assembly sleeve 210.

In certain illustrative embodiments, a method of cutting retaining band 20 on coil 15 of flexible pipe 10 is provided. Advancing assembly 150 can be positioned or otherwise disposed adjacent to coil 15 of flexible pipe 10. Advancing assembly 150 can have cutting instrument 50 disposed thereon and actuator 55 operatively coupled thereto. Cutting instrument 50 can be advanced towards coil 15 of flexible pipe 10 using actuator 55 to cut retaining band 20.

In certain illustrative embodiments, bracing apparatus 65 can be disposed on advancing assembly 150. Bracing apparatus 65 can contact coil 15 of flexible pipe 10 when band cutter apparatus 200 is positioned adjacent coil 15 of flexible pipe 10. Bracing apparatus 65 can be advanced towards coil 15 of flexible pipe 10, and contacted with coil 15 of flexible pipe 10. Coil 15 of flexible pipe 10 can be rotated about its central axis (in either a clockwise or counterclockwise direction), while bracing apparatus 65 is continuously advanced in the direction of coil 15 of flexible pipe 10. As one or more strands of flexible pipe 10 are unspooled from coil 15, one or more additional layers of flexible pipe 10 are exposed. Bracing apparatus 65 is pushed into contact with these additional layers of exposed flexible pipe 10 in order to provide consistent engagement against coil 15 as coil 15 grows smaller and pipe 10 is unspooled.

In certain illustrative embodiments, yet another method of cutting a retaining band on a coil of flexible pipe is provided. Advancing assembly 150 can be positioned or otherwise disposed adjacent to coil 15 of flexible pipe 10, and cutting instrument 50 can be advanced towards coil 15 of flexible pipe 10 to cutting retaining band 20. The step of advancing cutting instrument 50 towards coil 15 of flexible pipe 10 can include moving advancing assembly shaft 220 linearly from a retracted position to an extended position with respect to advancing assembly sleeve 210. Advancing assembly shaft 220 can be moved by actuator 55 operatively coupled thereto.

A plurality of gaps or recesses can be formed or disposed between the individual strands of pipe 10 on coil 15 of flexible pipe 10. Cutting instrument 50 can be advanced to fit within one of these recesses, so that the cutting blades on cutting instrument 50 are positioned to effectively cut retaining band 20. Coil 15 of flexible pipe 10 can be rotated about its central axis such that cutting instrument 50 comes into contact with retaining band 20 when cutting instrument 50 is positioned within, or near within, the recesses.

In certain illustrative embodiments, band cutter assembly 40 should be positioned with respect to coil 15 such that each of the cutting instruments 50 on band cutter assembly 40 is aligned towards, and within, the axial dimension of coil 15. In other words, cutting instruments 50 should be positioned inward of the outer edge of coil 15, such that cutting instruments 50 are aligned with the region where recesses between individual strands of pipe 10 will appear, such that cutting instruments 50 can fit within, or near within, the recesses. Otherwise, cutting instruments 50 will not be located where cutting of retaining bands 20 within the axial dimension of coil 15 can occur. In other embodiments, band cutter assembly 40 should be positioned with respect to coil 15 such that each of the cutting instruments 50 on band cutter assembly 40 are aligned with the base (instead of the axial dimension) of coil 15, so that cutting of retaining bands 20 can occur from the side of coil 15.

In certain illustrative embodiments, band cutter assembly 40 can be disposed on advancing assembly shaft 220. Helical springs 80 can be disposed longitudinally with respect to band cutter shaft 90 and band cutter sleeve 100 of band cutter assembly 40, such that helical springs 80 can move band cutter shaft 90 between an extended position and a retracted position with respect to band cutter sleeve 100 when cutting instrument 50 comes into contact with coil 15 of flexible pipe 10. Similarly, helical springs 80 can move cutting instrument 50 from the retracted position to the extended position with respect to band cutter sleeve 100 when cutting instrument 50 comes out of contact with coil 15 of flexible pipe 10.

In certain illustrative embodiments, band cutter assembly 40 can have first torsion spring 70a disposed between band cutter shaft 100 and first arm 50a of cutting instrument 50 and second torsion spring 70b disposed between band cutter shaft 100 and second arm 50b of cutting instrument 50, such that first torsion spring 70a and second torsion spring 70b are capable of moving cutting instrument 50 between a non-aligned position and an aligned position with respect to band cutter shaft 100. Thus, first torsion spring 70a and second torsion spring 70b are capable of moving cutting instrument 50 from an aligned position to a non-aligned position with respect to band cutter shaft 100 when cutting instrument 50 comes into contact with coil 15 of flexible pipe 10, and from a non-aligned position to an aligned position with respect to band cutter shaft 100 when cutting instrument 50 comes out of contact with coil 15 of flexible pipe 10. The spring tension of first torsion spring 70a and second torsion spring 70b must be properly set so that the springs can move between the aligned and non-aligned position without getting stuck in one or the other position.

It is to be understood that the present invention is not limited to the embodiment(s) described above and illustrated herein, but encompasses any and all variations falling within the scope of the appended claims.

What is claimed is:

1. A band cutter assembly for cutting a retaining band on a coil of flexible pipe, comprising:
a band cutter sleeve having a hollow interior;
a band cutter shaft having a proximal end and a distal end, wherein the distal end of the band cutter shaft is slidingly disposable within the band cutter sleeve; and
a cutting instrument having at least one cutting blade, wherein the cutting instrument is disposed on the proximal end of the band cutter shaft.

2. The band cutter assembly of claim 1, further comprising a helical spring disposed longitudinally with respect to the band cutter shaft and the band cutter sleeve, wherein the helical spring has a first end connectable to the band cutter shaft and a second end connectable to the band cutter sleeve, and wherein the helical spring is capable of moving the band cutter shaft between an extended position and a retracted position with respect to the band cutter sleeve.

3. The band cutter assembly of claim 2, wherein the helical spring is disposed inside the hollow interior of the band cutter sleeve and outside the band cutter shaft.

4. The band cutter assembly of claim 2, wherein the cutting instrument has a first arm and a second arm each having a distal end and a proximal end, and wherein the distal ends of the first arm and the second arm are separated by a gap and the proximal ends of the first arm and the second arm are connected to each other by a frame.

5. The band cutter assembly of claim 4, wherein the cutting instrument is generally horseshoe-shaped.

6. The band cutter assembly of claim 4, wherein a blade is disposed on at least one of the first arm and the second arm of the cutting instrument, on the opposite side of the arm on which the blade is disposed from the gap.

7. The band cutter assembly of claim 4, further comprising a first torsion spring disposed between the band cutter shaft and the first arm of the cutting instrument and a second torsion spring disposed between the band cutter shaft and the second arm of the cutting instrument, wherein the first torsion spring and the second torsion spring are capable of moving the cutting blade from a non-aligned position to an aligned position with respect to the band cutter shaft.

8. The band cutter assembly of claim 4, wherein the first torsion spring has a first leg that is connectable to the band cutter shaft and a second leg that is connectable to the first arm of the cutting instrument.

9. The band cutter assembly of claim 4, wherein the second torsion spring has a first leg that is connectable to the band cutter shaft and a second leg that is connectable to the second arm of the cutting instrument.

10. The band cutter assembly of claim 2, further comprising an actuator operatively coupled to the cutting instrument, wherein the actuator is capable of moving the cutting instrument linearly between an extended position and a retracted position.

11. A band cutter apparatus for cutting a retaining band on a coil of flexible pipe comprising:
a band cutter assembly and an advancing assembly;
wherein the band cutter assembly comprises:
a band cutter sleeve having a hollow interior,
a band cutter shaft having a proximal end and a distal end, wherein the distal end of the band cutter shaft is slidingly disposable within the band cutter sleeve, and
a cutting instrument having at least one cutting blade, wherein the cutting instrument is disposed on the proximal end of the band cutter shaft;
and wherein the advancing assembly comprises:
an advancing assembly sleeve having a hollow interior, and
an advancing assembly shaft having a proximal end and a distal end, wherein the distal end of the advancing assembly shaft is slidingly disposable within the advancing assembly sleeve.

12. The band cutter apparatus of claim 11, wherein the band cutter assembly is disposed on the proximal end of the advancing assembly shaft.

13. The band cutter apparatus of claim 11, wherein a helical spring is disposed longitudinally with respect to the band cutter shaft and the band cutter sleeve, and wherein the helical spring has a first end connectable to the band cutter shaft and a second end connectable to the band cutter sleeve, and wherein the helical spring is capable of moving the band cutter shaft between an extended position and a retracted position with respect to the band cutter sleeve.

14. The band cutter apparatus of claim 12, further comprising an actuator operatively coupled to the advancing assembly shaft and capable of moving the advancing assembly shaft linearly from a retracted position to an extended position with respect to the advancing assembly sleeve.

15. The band cutter apparatus of claim 12, further comprising a bracing apparatus disposed on the advancing assembly and capable of contacting the coil of flexible pipe when the band cutter apparatus is positioned adjacent the coil of flexible pipe.

16. A method of cutting a retaining band on a coil of flexible pipe, the method comprising:
disposing an advancing assembly adjacent to the coil of flexible pipe, the advancing assembly having a cutting instrument disposed thereon and an actuator operatively coupled thereto;
advancing the cutting instrument towards the coil of flexible pipe using the actuator; and
cutting the retaining band with the cutting instrument.

17. The method of claim 16, wherein the advancing assembly further comprises a bracing apparatus, and wherein the method further comprises the step of:
advancing the bracing apparatus towards the coil of flexible pipe; and
contacting the bracing apparatus with the coil of flexible pipe.

18. The method of claim 17, further comprising:
rotating the coil of flexible pipe about its central axis; and
continuing to advance the bracing apparatus towards the coil of flexible pipe as one or more strands of flexible pipe unspool from the coil and one or more additional layers of flexible pipe are exposed; and
contacting the bracing apparatus with the one or more additional layers of flexible pipe.

19. A method of cutting a retaining band on a coil of flexible pipe, the method comprising:
disposing an advancing assembly adjacent to the coil of flexible pipe, the advancing assembly comprising:
an advancing assembly sleeve having a hollow interior,
an advancing assembly shaft slidingly disposable within the advancing assembly sleeve, and
a cutting instrument having at least one cutting blade, wherein the cutting instrument is disposed on the proximal end of the advancing assembly shaft;
advancing the cutting instrument towards the coil of flexible pipe; and
cutting the retaining band with the cutting instrument.

20. The method of claim 19, wherein the step of advancing the cutting instrument towards the coil of flexible pipe comprises:
moving the advancing assembly shaft linearly from a retracted position to an extended position with respect to the advancing assembly sleeve.

21. The method of claim 19, wherein the advancing assembly shaft is moved by an actuator operatively coupled to the advancing assembly shaft.

22. The method of claim 19, wherein a plurality of recesses are disposed between the individual pipe strands on the coil of flexible pipe, and wherein the method further comprises:
advancing the cutting instrument to fit within one of the recesses.

23. The method of claim 19, further comprising:
rotating the coil of flexible pipe about its central axis such that the cutting instrument comes into contact with the retaining band.

24. The method of claim 19, wherein a band cutter assembly is disposed on the advancing assembly shaft, the band cutter assembly comprising:
a band cutter sleeve having a hollow interior;
a band cutter shaft having a proximal end and a distal end, wherein the distal end of the band cutter shaft is slidingly disposable within the band cutter sleeve; and
a cutting instrument having at least one cutting blade, wherein the cutting instrument is disposed on the proximal end of the band cutter shaft.

25. The method of claim 24, wherein the band cutter assembly further comprises:
a helical spring disposed longitudinally with respect to the band cutter shaft and the band cutter sleeve, wherein the helical spring has a first end connectable to the band cutter shaft and a second end connectable to the band cutter sleeve, and wherein the helical spring is capable of moving the band cutter shaft between an extended position and a retracted position with respect to the band cutter sleeve,
and wherein the helical spring moves the cutting blade from the extended position to the retracted position with respect to the band cutter sleeve when the cutting instrument comes into contact with the coil of flexible pipe.

26. The method of claim 25, wherein the helical spring moves the cutting blade from the retracted position to the extended position with respect to the band cutter sleeve when the cutting instrument comes out of contact with the coil of flexible pipe.

27. The method of claim 24, wherein the band cutter assembly further comprises:
a first torsion spring disposed between the band cutter shaft and the first arm of the cutting instrument and a second torsion spring disposed between the band cutter shaft and the second arm of the cutting instrument, wherein the first torsion spring and the second torsion spring are capable of moving the cutting blade between a non-aligned position and an aligned position with respect to the band cutter shaft,
and wherein the first torsion spring and the second torsion spring move the cutting blade from an aligned position to a non-aligned position with respect to the band cutter shaft when the cutting instrument comes into contact with the coil of flexible pipe.

28. The method of claim 27, wherein the first torsion spring and the second torsion spring move the cutting blade from a non-aligned position to an aligned position with respect to the band cutter shaft when the cutting instrument comes out of contact with the coil of flexible pipe.

29. The method of claim 24, wherein the band cutter assembly further comprises:
a helical spring disposed longitudinally with respect to the band cutter shaft and the band cutter sleeve, wherein the helical spring has a first end connectable to the band cutter shaft and a second end connectable to the band cutter sleeve, and wherein the helical spring is capable of moving the band cutter shaft between an extended position and a retracted position with respect to the band cutter sleeve; and
a first torsion spring disposed between the band cutter shaft and the first arm of the cutting instrument and a second torsion spring disposed between the band cutter shaft and the second arm of the cutting instrument, wherein the first torsion spring and the second torsion spring are capable of moving the cutting blade from a non-aligned position to an aligned position with respect to the band cutter shaft.

30. The method of claim 29, wherein the helical spring moves the cutting blade from the extended position to the retracted position with respect to the band cutter sleeve when the cutting instrument comes into contact with the coil of flexible pipe, and from the retracted position to the extended position with respect to the band cutter sleeve when the cutting instrument comes out of contact with the coil of flexible pipe, and wherein the first torsion spring and the second torsion spring move the cutting blade from an aligned position to a non-aligned position with respect to the band cutter shaft when the cutting instrument comes into contact with the coil of flexible pipe, and from a non-aligned position to an aligned position with respect to the band cutter shaft when the cutting instrument comes out of contact with the coil of flexible pipe.
